(19) United States
(12) Patent Application Publication
(10) Pub. No.: US 2015/0316831 A1
(43) Pub. Date: Nov. 5, 2015

(54) DIAMOND-BASED SUPERCONTINUUM GENERATION SYSTEM

(71) Applicant: NEWPORT CORPORATION, Irvine, CA (US)

(72) Inventors: James Kafka, Palo Alto, CA (US); Alan Petersen, Palo Alto, CA (US)

(73) Assignee: Newport Corporation, Irvine, CA (US)

(21) Appl. No.: 14/649,793

(22) PCT Filed: Dec. 25, 2013
(86) PCT No.: PCT/US2013/077730

§ 371 Date: Jun. 4, 2015

Related U.S. Application Data
(60) Provisional application No. 61/745,837, filed on Dec. 26, 2012.

(51) Int. Cl. G02F 1/35; H01S 3/0933; G02B 1/11; H01S 3/16; H01S 3/08; G02F 1/355; H01S 3/00; H01S 3/0941

(52) U.S. Cl. CPC G02F 1/353; H01S 3/0092; H01S 3/0933; H01S 3/0941; H01S 3/1675; H01S 3/1631; H01S 3/1636; H01S 3/1648; H01S 3/1618; H01S 3/1623; H01S 3/1655; H01S 3/08059; G02F 1/3551; G02B 1/11; G02F 2001/3528

(57) ABSTRACT

A supercontinuum source using diamond as the supercontinuum material is disclosed that works at higher average powers than previous sources. The thermal properties of diamond allow continuum to be generated directly from an oscillator at high repetition rates. The diamond does not need to be translated even at multi-Watt power levels. This diamond continuum source can be based on a single filament and thus possesses excellent stability and phase coherence.

### BACKGROUND

Supercontinuum generation is a nonlinear optical process wherein laser light undergoes nonlinear optical processes to produce an output signal having a broad spectral bandwidth while retaining a relatively high spatial coherence. As a result, the output of a supercontinuum generation system may be used in a number of applications which typically would utilize a tunable laser system.

Presently, there are a number of supercontinuum generation devices available. For example, one family of supercontinuum generation devices utilizes a low average and low peak power pulsed pump system to provide a pump signal to an optical fiber having high nonlinearity. As shown in FIG. 1, prior art fiber-based systems 1 generally include a pump source which emits a pump signal. Often one or more optical elements 5 are used to condition or otherwise modify the pump signal. Thereafter, a lens system 7 is used to focus the pump signal into an optical fiber 9. Thereafter, an outcoupler 11 may be used to extract the multiple wavelength signals 15 from the optical fiber 9. Further, one or more lens or other optical elements 13 may be used to condition or modify the signal emitted from the optical fiber 9. Often a photonic crystal fiber (hereinafter PCF) is used as the optical fiber. In the alternative, a step index or tapered fiber is substituted for the PCF.

While these fiber-based systems have proved useful in generating continuum, a number of shortcomings have been identified. For example, fiber-based systems often tend to be limited to low average power applications. In addition, fiber-based continuum generation systems tend to offer lower phase coherence and stability than desired for some applications. For example, as described in the article in Applied Physics B 97, 561 (2009), when the continuum is produced by PCF with “longer pulses and other unfavorable conditions the output pulses show imperfect coherence, energy fluctuations and highly structured spectral energy densities.” The continuum produced in these fibers is further studied in detail in Optics Express 15, 5699 (2007). More specifically, the broad and smooth continuum (see FIG. 2) “has its origin in a rather complicated broadening mechanism determined by soliton dynamics . . . ” and that “noise will lead to spectral and temporal fluctuations in the generated supercontinuum and results in a poor recompression quality . . . ” As a result, the authors of the research detailed in Optics Express 15, 5699 chose to reduce the input power to the PCF and generated a single soliton which produced a stable compressible pulse but over a much smaller bandwidth (See FIG. 3). Thus, there is a tradeoff between pulse stability and broad tunability when using continuum generated in fibers.

In contrast, supercontinuum generation systems may utilize a high peak power, ultrashort optical pulse and a bulk material to generate the desired broad spectral bandwidth output. For example, Optical Parametric Amplifiers (hereinafter OPAs) which are desirable sources of ultrashort pulses are almost always seeded by a supercontinuum that is generated in a bulk material.

For example, typical OPA systems can be configured to operate at 1 kHz or 5 kHz. However, OPAs have been built with 250 kHz Ti:sapphire amplifiers as described in Optics Letters 19, 1855 (1994). More recently a 1 MHz OPA was pumped by an Yb doped laser and a fiber amplifier. (See Optics Express 15, 5699 (2007)). In addition, a 2 MHz OPA was used to amplify a Ti:sapphire laser as the seed as well (See ASSP 2008 paper TuA3). All of these systems generated femtosecond pulses. A picosecond OPA has been demonstrated at 50 MHz repetition rate (Optics Express 17, 7304 (2009)). This system produced pulses of ˜1 ps and used a 1 meter long photonic crystal fiber (PCF) to generate the seed source. The gain crystal for the OPA was a periodically poled Lithium Niobate crystal (PPLN). No measurements of the stability of the source are given, however.

At repetition rates below 1 MHz, a system generating continuum in a bulk material may be preferred. When sufficient peak power is focused into a material such as sapphire the beam collapses and forms a single filament due to self focusing. When a single filament is formed, the wavelength shifted pulses produced are stable in time (each pulse is the same) and a large bandwidth can even be compressed to a pulse duration that is substantially shorter than the pump pulse (due to a property called phase coherence.)

Different materials for generating a single filament continuum are compared in Applied Physics B 97, 561 (2009). The authors conclude that the threshold for continuum generation is the same as the critical power for self focusing. This in turn depends on the quantity n₀×n₂ where n₀ is the refractive index and n₂ is the nonlinear index. They calculate that the crystal KGW has a value of 20 (10⁻¹⁶ cm²/W) and YVO₄ has a value of 30 making them suitable for lower threshold continuum generation. They then demonstrate continuum with several different laser sources. Only one source is at a repetition rate higher than 5 MHz and that is an 80 MHz Ti:sapphire laser oscillator that produces extremely short pulses of 7 fs duration. With a KGW crystal they observed continuum generation with only 10 nJ of energy per pulse. While this approach proved somewhat successful, a number of shortcomings have been identified. For example, the authors noted that “If the average power becomes too high, the continuum will only light up briefly and then cease again often with permanent damage to the crystal. In recent work we showed that this can be avoided to some degree by rapid motion of the crystal.” As such, a high repetition rate OPA based system that is seeded by continuum utilizing a bulk material would require a complex rapid crystal movement system. Further, prior art supercontinuum generation devices using prior art bulk materials are generally operable only at a low pulse repetition rate thereby resulting in low average power.

Thus, in light of the foregoing, there is an ongoing need for a simple, bulk material-based supercontinuum generation system. Further, there is an ongoing need for a bulk material-based supercontinuum source that produces a stable single filament supercontinuum at a high repetition rate and, thus, having high average power.

### SUMMARY

The present application discloses various embodiments of a bulk-material based supercontinuum generations system. In more specific embodiments, the present application discloses various embodiments of a diamond-based supercontinuum generation system.

In one embodiment, the present application discloses a laser system configured to generate a continuum output. More specifically, the laser system includes at least one pump laser system configured to output sub-picosecond pump signals, and at least one single filament diamond-based continuum generator in optical communication with the pump laser system, the continuum generator configured to output at least one continuum signal.

In another embodiment, the present application discloses a laser system configured to generate a continuum output. More specifically, the laser system includes at least one pump laser system configured to output sub-picosecond pump signals, and at least one single filament continuum generator formed in a bulk material, the continuum generator configured to remain substantially stationary during operation of the laser system, the continuum generator configured to output a continuum signal of about 5 W or greater.

Other features and advantages of the embodiments of the supercontinuum generation system as disclosed herein will become apparent from a consideration of the following detailed description.

### BRIEF DESCRIPTION OF THE DRAWINGS

Various embodiments of the supercontinuum generation system will be explained in more detail by way of the accompanying drawings, wherein:

FIG. 1 shows a schematic of a prior art fiber-baser laser system configured to generate an supercontinuum output signal;

FIG. 2 shows graphically the bandwidth profile of the output signal generated by a laser system utilizing a photonic crystal fiber;

FIG. 3 shows graphically the bandwidth profile of the output signal generated by a laser system using a photonic crystal fiber wherein the input power of the pump signal supplied to the photonic crystal fiber is reduced to produce a stable compressible pulse;

FIG. 4 shows a schematic of an embodiment of a novel diamond-based supercontinuum generation system;

FIG. 5a shows graphically the wavelength characteristics of at least one pump signal used in the diamond-based supercontinuum generation system shown in FIG. 4;

FIG. 5b shows graphically the broadened wavelength characteristics of the pump signal used in the diamond-based supercontinuum generation system shown in FIGS. 4 and 5a;

FIG. 6a shows schematically another embodiment of a diamond-based supercontinuum generation system;

FIG. 6b shows graphically the broadened wavelength characteristics of a pump signal from a Ti:sapphire laser system used in the diamond-based supercontinuum generation system shown in FIG. 4;

FIG. 7 shows a schematic of an embodiment of a laser system which uses a supercontinuum signal as a seed signal for one or more optical parametric oscillators.

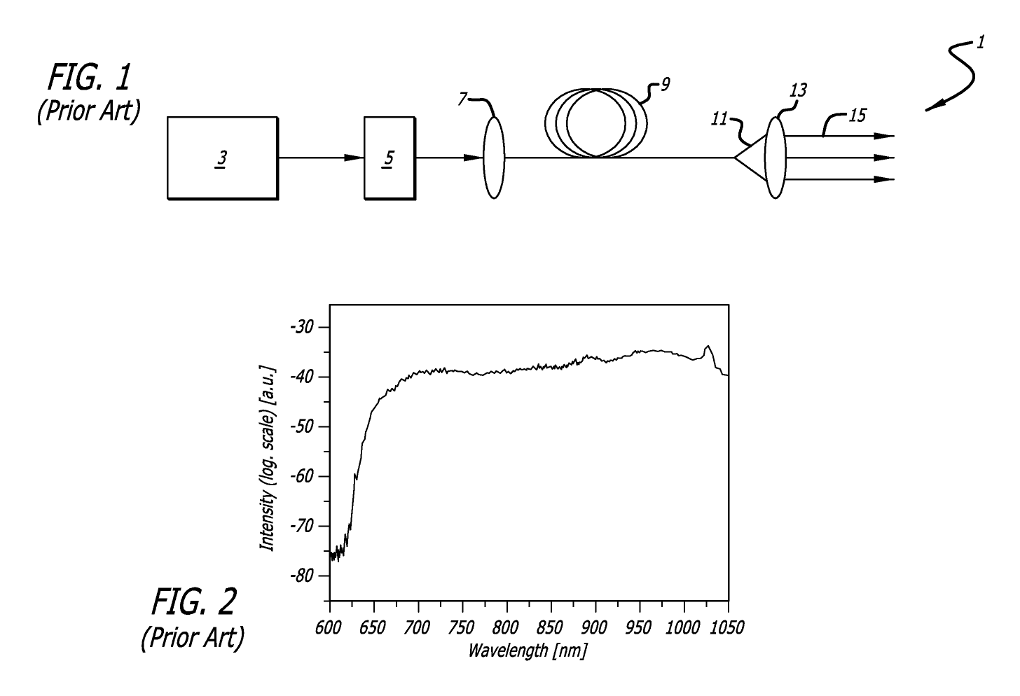

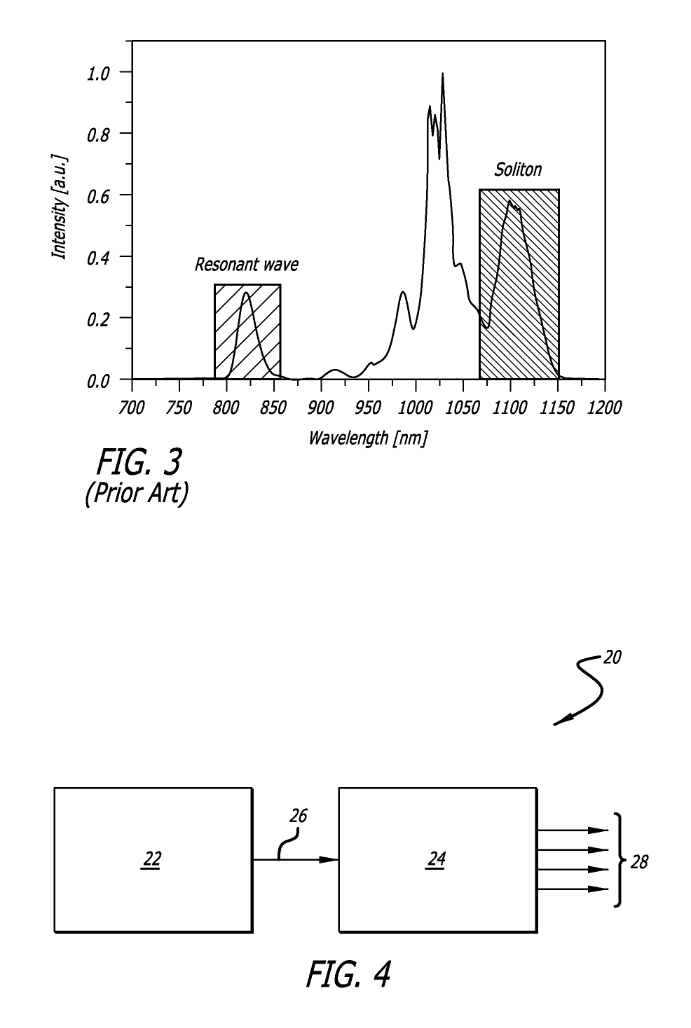

### DETAILED DESCRIPTION

FIG. 4 shows an embodiment of a laser system configured to generate at least one supercontinuum output signal. In the present application the terms supercontinuum and continuum are used interchangeably and refer to a broad spectral bandwidth while retaining a relatively high spatial coherence. Those skilled in the art will appreciate that there are a number of applications for continuum generation in diamond or other materials as described below. The continuum generation process described below effectively redistributes the power of a high repetition rate pulse train into a broader spectrum of wavelengths, which may not easily be generated directly with an alternate laser source. One or more of these shifted spectral regions may be selected and used for an application requiring a wavelength other than that of the pump laser. In particular, different spectral regions may be used to selectively excite different fluorescent proteins in high resolution biological imaging. Two appropriately spaced portions of a continuum may also be combined in a nonlinear material and a difference signal generated, at a longer wavelength, generally in the infrared. Also, if appropriately distributed in time, a spectral continuum may be temporally compressed, using well-known techniques including grating and prism pairs, to produce a much shorter optical pulse. A portion of a continuum spectrum may also be amplified in an optical parametric amplifier (OPA). The amplified signal may then itself be used in any of the above-mentioned applications.

As shown in FIG. 4, the supercontinuum generation laser system 20 includes at least one pump laser system 22 in optical communication with at least one continuum generator 24. In one embodiment, the pump laser system 22 is configured to emit sub-picosecond pump signals 26 to the continuum generator 24. For example, in one embodiment, the pump laser system 22 comprises a diode-pumped solid state oscillator. More specifically, the pump laser 22 may comprise a Yb:CaF₂ oscillator. In another embodiment, the pump laser system 22 comprises a Yb:KGW, Yb:KYW, Yb:CALGO, Yb:glass, Cr:LiCAF, Cr:LiSAF, Cr:LiSCAF, or Cr:LiCaGaF oscillator. In yet another embodiment, the pump laser system comprises a Ti:sapphire or Cr:ZnSe laser system.

Referring again to FIG. 4, the pump laser system 22 may be configured to output a pulsed pump signal 26 to the continuum generator 24 having a peak power of about 0.2 MW or more. In a more specific embodiment, the pump signal 26 may have a peak power of about 1 MW or more. Optionally, the pump signal 26 may have a peak power of about 1.5 MW. As such, it is desirable that the pump laser 22 emits a pump signal 26 at a power greater than the self-focusing threshold. Self-focusing occurs when the intensity of a beam is sufficiently high in a nonlinear material. At some intensity the effect of the nonlinear index n₂ becomes significant. For a beam with a Gaussian spatial profile, the center of the beam is more intense and thus experiences a higher index. The higher index on axis creates a lens that delays the center of the beam and causes the beam to self-focus upon itself. The intensity of the beam then increases further and the beam focusses more tightly until diffraction or other processes provide a limit. The intensity required for this process to begin is called the self-focusing threshold. As such, any variety of laser systems, optical amplifiers, and/or optical oscillators may be used as a pump source provided that the output pump signal 26 is at a peak power sufficient to generate self focusing.

Further, the pump laser 22 may output a pump signal at a variety of wavelengths. For example, in one embodiment, the pump signal 26 has a wavelength of about 300 nm to about 3000 nm. More specifically, the pump signal 26 may have a wavelength of about 600 nm to about 1800 nm. Optionally, the pump signal 26 may have a wavelength of about 750 nm to about 1100 nm. In another embodiment, the pump signal 26 has a wavelength of about 1000 nm to about 1100 nm.

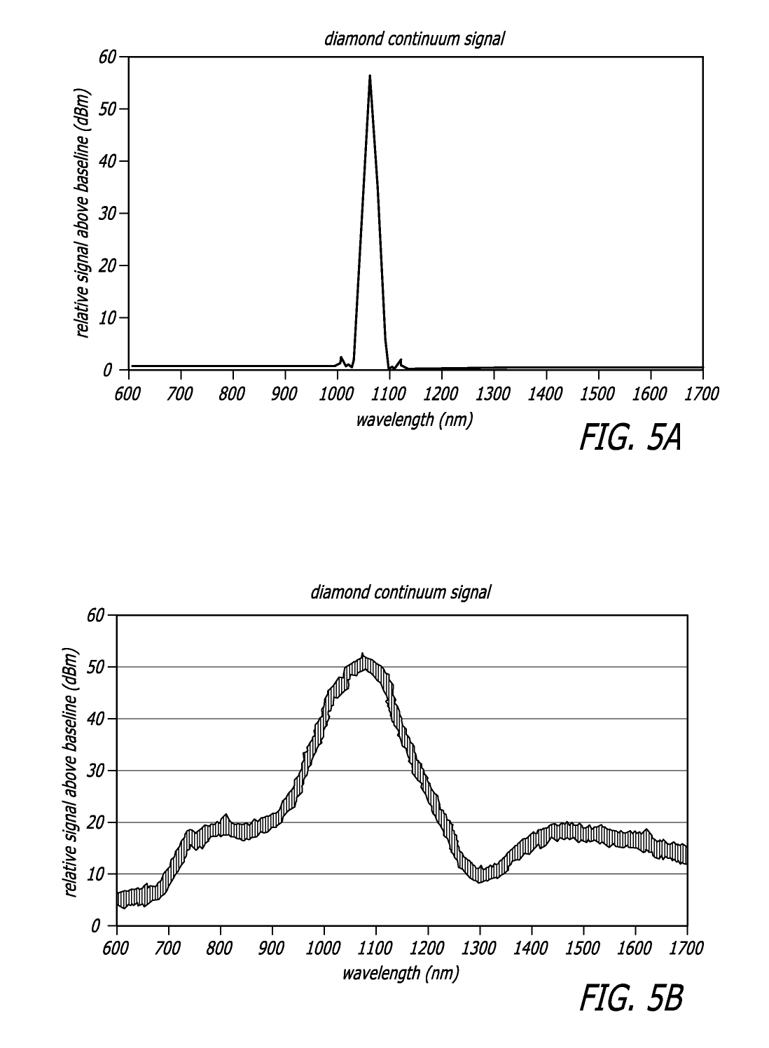

As shown in FIGS. 4, 5a, and 5b, the continuum generator 24 receives the high power, relatively narrow bandwidth pump signal 26 from the pump laser system 22 and emits a lower power, broad bandwidth continuum signal. For example, FIG. 5a shows graphically the wavelength characteristics of a pump signal 26. As shown in FIGS. 4, 5a, and 5b, the pump signal 26 consists of a signal wavelength signal having essentially all its energy at 1047 nm. In contrast, the continuum generator 24 receives the pump signal 26 from the pump laser system 22 and emits a broad wavelength signal 28.

In one embodiment, the continuum generator 24 comprises at least one single filament diamond-based device. There are a number of considerations in designing a practical continuum generator 24. For example, a useful amount of spectral broadening must be produced in the bulk material forming the continuum generator at an intensity below that material's damage threshold. The spectral broadening necessarily occurs at a very high intensity in a small volume within the solid material and involves some optical loss. Such loss often involves heating and damage to the material either within the bulk or at a surface of the continuum generator 24. The extremely high thermal conductivity of diamond mitigates this local heating within the bulk, even in a static crystal, while its desirable self-focusing threshold (diamond has a value of about 30×10⁻¹⁶ cm²/W) allows for significant continuum generation. As such, unlike prior art devices which required the continuum generator to be moved during use, the continuum generator 24 described herein may remain substantially stationary during use. Further, the length of the crystal or bulk material forming the continuum generator 24 must be long enough for self-focusing to occur and establish a high intensity optical filament. This filament will be self-terminating, due to other linear or nonlinear optical effects. The crystal must also be long enough such that the exit surface of the crystal is beyond the end of the filament formed therein, to avoid damage to that surface.

Further, continuum generation in diamond-based continuum generator 24 is also affected by the propagation direction and polarization of the pump beam within the crystal. Propagation along a <110> direction, with polarization in a <111> direction (along the carbon-carbon bonds) provides the production of a stable and efficient continuum output signal near continuum generation threshold. Once well above continuum generation threshold (i.e. 1.5 times supercontinuum threshold) alternative polarizations may be used. Given the relatively high Fresnel reflection from a normal incidence diamond surface Brewster-angle entrance and exit surfaces may be advantageous. Thus, a diamond rhomb, with particular crystalline orientation is preferred, although those skilled in the art will appreciate that the shape and dimensions of the bulk material forming the continuum generator 24 may be tailored as desired. Alternatively, broadband AR (anti-reflection) coatings may be applied to the substantially normal incident surfaces. Optionally, any number of alternate materials may be used to form the continuum generator 24. For example, SiC, GaN, and/or AlN may be used to form the continuum generator. As such, other high thermal conductivity, crystalline materials may be substituted for diamond in forming the continuum generator 24.

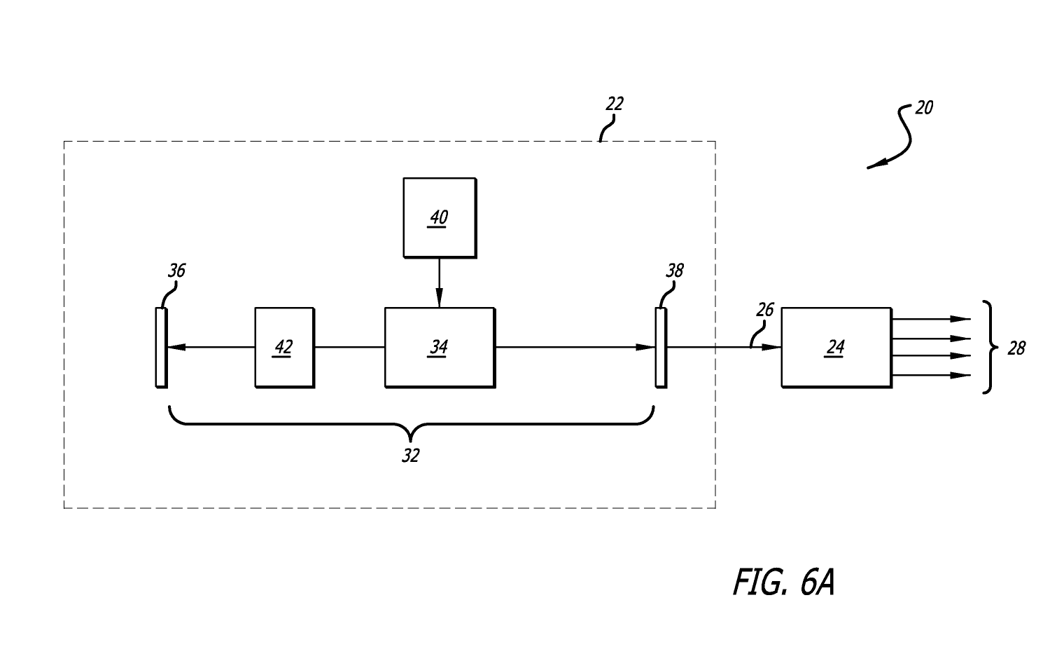

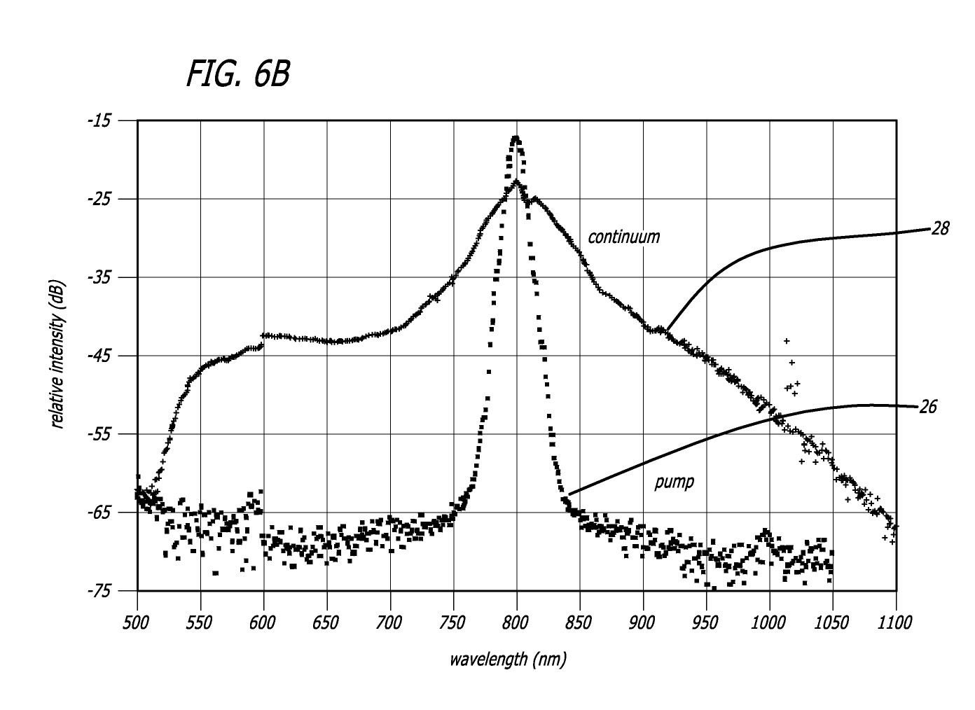

FIG. 6a shows a more detailed schematic diagram of one embodiment of the continuum generation system 20 shown in FIG. 4. In the present embodiment, the pump laser 22 includes at least one gain medium 34 pumped by a diode pump source 40. In one embodiment, the gain medium is a solid state material. For example, the gain medium 34 may be Yb:CaF₂. In the alternative, the gain medium 34 may be Yb:KGW, Yb:KYW, Yb:CALGO, Yb:glass, Cr:LiCAF, Cr:LiSAF, Cr:LiSCAF, or Cr:LiCaGaF. Optionally, the pump laser 22 may comprise a Ti:sapphire or Cr:ZnSe laser system. For example, in one embodiment the Ti:sapphire laser system used to form the pump laser 22 is configured to output sub-picosecond output pulses. In an more specific embodiment, the Ti:sapphire laser system is configured to output 100 fs pulses.

Referring again to FIG. 6a, the gain medium 34 may be positioned between a first mirror 36 and at least a second mirror or outcoupler 38. As such, the first and second mirrors 36, 38 may cooperatively form a cavity 32 within the pump laser system 22. Further, at least additional supplemental optical element 42 may be positioned within the pump laser system 22. Exemplary optical elements include, without limitations, semiconductor saturable absorber mirrors, mode-locking devices, lens and lens systems, mirrors, prisms, gratings, filters, acousto-optic devices, and the like. In addition, at least one lens or other focusing device may be used to focus the pump signal 26 into the continuum generator 24. In the illustrated embodiment, the continuum generator 24 is located outside the pump laser system 22. Optionally, the pump laser system 22 and continuum generator 24 may be located within a single housing.

As shown in FIG. 4, the continuum generator 24 emits at least one continuum signal 28 when irradiated by the pump signal 26. In one embodiment, the continuum generator 24 emits continuum signals 28 at a repetition rate of at least about 1 MHz. In another, the continuum generator 24 emits continuum signals 28 at a repetition rate of at least about 5 MHz. In yet another embodiment, the single filament diamond-based continuum generator 24 emits continuum signals 28 at a repetition rate of at least about 10 MHz. Further, the single filament diamond-based continuum generator 24 may be configured to emit continuum signals 28 having an average power of about 1 W or more. In another embodiment, the continuum generator 24 may be configured to emit continuum signals 28 having an average power of about 5 W or more. Optionally, the continuum generator 24 may be configured to emit continuum signals 28 having an average power of about 10 W or more.

FIG. 6b shows the wavelength characteristics of a pump signal 26 from a Ti:sapphire pump laser system 22 as compared with the continuum signals 28 emitted from the continuum generator 24 shown in FIG. 4.

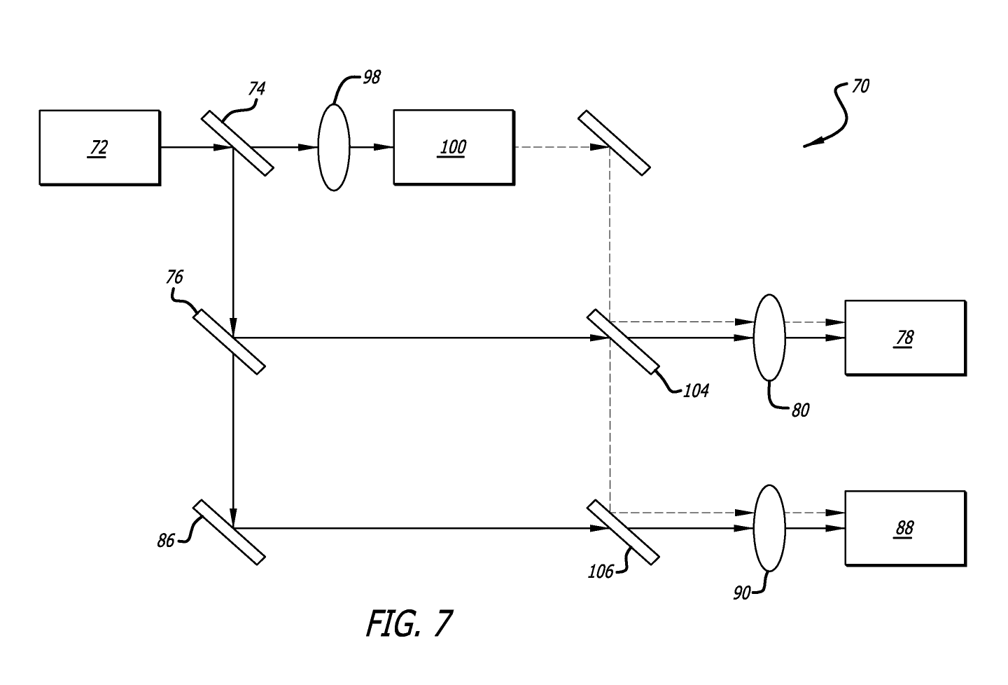

FIG. 7 shows an embodiment of a laser system 70 which uses a continuum signal as a seed for one or more optical parametric oscillators. As shown, the laser system 70 includes at least one pump laser system 72 to provide at least one pump signal to the continuum generator 100. Exemplary pump laser systems 72 include the diode-pumped solid state pump laser devices described above. In one embodiment a portion of the pump signal is directed by a beam splitter 74 to beam splitter 76, which in turn directs a portion of the pump signal to a first optical parametric amplifier 78 (hereinafter first OPA 78). Also, a portion of the pump signal is directed by a reflector 86 to at least a second optical parametric amplifier 88 (hereinafter second OPA 88).

Referring again to FIG. 7, the beam splitter 74 directs a portion of the pump signal to a focusing device 98 which focuses the pump signal into the continuum generator 100. At least one continuum signal is emitted from the continuum generator 100 and directed into the first OPA 78 and second OPA 88, by the optical elements 104, 106 respectively. Optionally at least additional optical device 80 may be used to condition the pump signal and/or continuum signal prior to irradiating the first OPA 78. Similarly, at least additional optical device 90 may be used to condition the pump signal and/or continuum signal prior to irradiating the second OPA 88. In one embodiment, at least one of the first and second OPAs comprises periodically poled KTP (PPKTP). In the alternative, at least one of the first and second OPAs may contain Lithium Tantalate, periodically poled Lithium Tantalate (PPLT), LBO and/or BBO. In another embodiment, the pump signal from pump laser system 72 may be frequency doubled for pumping one or both OPAs.

The embodiments disclosed herein are illustrative of the principles of the invention. Other modifications may be employed which are within the scope of the invention. Accordingly, the devices disclosed in the present application are not limited to that precisely as shown and described herein.

1. A laser system configured to generate a continuum output, comprising:
at least one pump laser system configured to output sub-picosecond pump signals; and
at least one single filament diamond-based continuum generator in optical communication with the pump laser system, the continuum generator configured to output at least one continuum signal.

2. The laser system of claim 1 wherein the pump laser system comprises a diode-pumped solid state oscillator.

3. The laser system of claim 1 wherein the pump laser system comprises a diode-pumped Yb:CaF oscillator

4. The laser system of claim 1 wherein the pump laser system comprises at least one diode-pumped laser system selected from the group consisting of Yb:KGW, Yb:KYW, Yb:CALGO, Yb:glass, Cr:LiCAF, Cr:LiSAF, Cr:LiSCAF and Cr:LiCaGaF oscillators.

5. The laser system of claim 1 wherein the pump laser system comprises a Ti:sapphire laser system.

6. The laser system of claim 1 wherein the pump laser system is configured to output pump signals having a peak power of at least about 0.2 MW.

7. The laser system of claim 1 wherein the pump laser system has a peak power of at least about 1 MW.

8. The laser system of claim 1 wherein the pump laser system has a peak power of least about 1.5 MW.

9. The laser system of claim 1 wherein the pump signal has a wavelength of about 600 nm to about 1800 nm.

10. The laser system of claim 1 wherein the pump signal has a wavelength of about 750 nm to about 1100 nm.

11. The laser system of claim 1 wherein the pump signal has a wavelength of about 1000 nm to about 1100 nm.

12. The laser system of claim 1 further comprising at least one focusing device configured to focus the pump signals from the pump laser system into the single filament diamond-based continuum generator.

13. The laser system of claim 12 wherein the focusing device comprises at least one optical lens.

14. The laser system of claim 12 wherein the focusing device comprises at least one curved reflector.

15. The laser system of claim 1 wherein the pump laser further includes at least one semiconductor saturable absorber minor.

16. The laser system of claim 1 wherein the single filament diamond-based continuum generator is substantially stationary during use.

17. The laser system of claim 1 wherein the single filament diamond-based continuum generator emits continuum signals at a repetition rate of at least about 1 MHz.

18. The laser system of claim 1 wherein the single filament diamond-based continuum generator emits continuum signals at a repetition rate of at least about 5 MHz.

19. The laser system of claim 1 wherein the single filament diamond-based continuum generator emits continuum signals at a repetition rate of at least about 10 MHz.

20. The laser system of claim 1 wherein the single filament diamond-based continuum generator emits continuum signals having an average power of about 1 W or more.

21. The laser system of claim 1 wherein the single filament diamond-based continuum generator emits continuum signals having an average power of about 5 W or more.

22. A laser system configured to generate a continuum output, comprising:
at least one pump laser system configured to output sub-picosecond pump signals; and,
at least one single filament continuum generator formed in a bulk material, the continuum generator configured to remain substantially stationary during operation of the laser system, the continuum generator configured to output a continuum signal of about 5 W or greater.

23. The laser system of claim 22 wherein the continuum generator has a repetition rate of about 10 MHz or greater.

24. The laser system of claim 22 wherein the bulk material comprises diamond.

25. The laser system of claim 24, wherein the output from the diamond-based continuum generator configured to seed an optical parametric amplifier.

26. The laser system of claim 24, wherein the output from the diamond-based continuum generator is temporally compressed.

27. The laser system of claim 22, wherein the output is used for multi-photon microscopy.

28. The laser system of claim 22, wherein the output is used for difference frequency generation.

29. The laser system of claim 22 wherein the bulk material comprises anti-reflective coated diamond.

30. The laser system of claim 29 wherein the anti-reflective coating comprises silica.
